(19) United States
(12) Patent Application Publication
(10) Pub. No.: US 2025/0362545 A1
(43) Pub. Date: Nov. 27, 2025

(54) DISPLAY MODULE AND DISPLAY APPARATUS

(71) Applicants: BEIJING BOE DISPLAY TECHNOLOGY CO., LTD., Beijing (CN); BOE TECHNOLOGY GROUP CO., LTD., Beijing (CN)

(72) Inventors: Jianting WANG, Beijing (CN); Weijia DU, Beijing (CN); Zheng WANG, Beijing (CN); Zhengyan WAN, Beijing (CN); Bing BAI, Beijing (CN); Xue TIAN, Beijing (CN); Tianyang HAN, Beijing (CN)

(21) Appl. No.: 18/998,366

(22) PCT Filed: Apr. 17, 2024
(86) PCT No.: PCT/CN2024/088185

§ 371 Date: Jan. 24, 2025

(30) Foreign Application Priority Data
May 31, 2023 (CN) 202310637795.6

(51) Int. Cl. G02F 1/1335; G02F 1/1333; G02F 1/13357

(52) U.S. Cl. CPC G02F 1/133628; G02F 1/133385; G02F 1/133608

(57) ABSTRACT

The present disclosure provides a display module and a display device. The display module includes a light board configured to emit light towards a first side, a sealed cavity component on a first side of the light board, including a first light transmissive board close to the light board, a second light transmissive board away from the light board and a side wall extending between the first light transmissive board and the second light transmissive board, in which the first light transmissive board, the second light transmissive board and the side wall surround a cavity, and the side wall has a first opening configured to output air from the cavity and a second opening configured to input air into the cavity, a liquid crystal panel on a side of the sealed cavity component away from the light board.

### RELATED APPLICATION

The present application claims the benefit of Chinese Patent Application No.202310637795.6 filed on May 31, 2023, the entire disclosure of which is incorporated herein by reference.

### TECHNICAL FIELD

The present disclosure relates to the field of display technology, in particular to a display module and a display device.

### BACKGROUND

For display devices such as liquid crystal screens, due to the heating effect of the light board and other electronic components, the temperature of the display device, especially the internal display module, generally increases during display. In outdoor or semi-outdoor scenes with sunlight exposure, or in other scenes involving high brightness display requirements or high temperature conditions, temperature rise is often more significant. Such significant temperature rise not only affects the display effect of the device, but also accelerates the decay of some components or film materials inside the device when it works at high temperatures for a long time, thus reducing the service life of the device.

### SUMMARY

In view of the above, the present disclosure provides a display module and a display device, which may alleviate, reduce, or even eliminate the above-mentioned problems.

According to one aspect of the present disclosure, a display module is provided, which includes: a light board, configured to emit light towards a first side; a sealed cavity component, on a first side of the light board, including a first light transmissive board close to the light board, a second light transmissive board away from the light board and a side wall extending between the first light transmissive board and the second light transmissive board, in which the first light transmissive board, the second light transmissive board and the side wall surround a cavity, and the side wall has a first opening configured to output air from the cavity and a second opening configured to input air into the cavity; a liquid crystal panel, on a side of the sealed cavity component away from the light board.

In some embodiments, the first light transmissive board is a high transmissive glass board, and the second light transmissive board is a diffusion board.

In some embodiments, the first light transmissive board and the second light transmissive board are both high transmissive glass boards.

In some embodiments, the sealed cavity component includes: a first air cavity member, including a first extension portion extending along an upper side wall of the sealed cavity component, the first extension portion surrounding a first air cavity, and an end of the first extension portion having the first opening, in which the upper side wall is an upward side wall of the sealed cavity component in a designed direction for use of the display module; and a second air cavity member, including a second extension portion extending along a lower side wall of the sealed cavity component, the second extension portion surrounding a second air cavity, an end of the second extension portion having the second opening, in which the lower side wall being a side wall opposite to the upper side wall.

In some embodiments, the first extension portion has multiple third openings discretely arranged between the first air cavity and the cavity, and the second extension portion has multiple fourth openings discretely arranged between the second air cavity and the cavity.

In some embodiments, the display module further includes: a first ventilation duct, a first port of the first ventilation duct being connected to the first opening; a second ventilation duct, a first port of the second ventilation duct being connected to the second opening; an air pump, connected to a second port of the first ventilation duct and a second port of the second ventilation duct, and configured to drive air to flow in the first ventilation duct, the second ventilation duct and the cavity.

In some embodiments, the display module further includes: a first sealing ring, configured to seal the first opening between the first port of the first ventilation duct and the first opening; a second sealing ring, configured to seal the second opening between the first port of the second ventilation duct and the second opening.

In some embodiments, the display module further includes: a back board, on a second side of the light board, the second side being an opposite side of the first side, in which the air pump is fixed on a side of the back board away from the light board.

In some embodiments, the display module further includes: a shock-absorbing pad, covering at least a portion of a surface of the air pump.

In some embodiments, the display module further includes: a temperature sensor, installed on the first side of the light board and configured to sense the temperature at its installation position; a controller, configured to generate a control signal based on the temperature sensed by the temperature sensor, in which the control signal is used to control the air pump to be turned on or off.

In some embodiments, the controller is further configured to: generate, in response to the temperature being greater than a first threshold, a first control signal for controlling the air pump to be turned on; generate, in response to the temperature being lower than a second threshold, a second control signal for controlling the air pump to be turned off, in which the second threshold is lower than the first threshold.

In some embodiments, the temperature sensor is arranged on an upper part of the liquid crystal panel, the upper part being an upper portion of the liquid crystal panel in a designed direction for use of the display module.

In some embodiments, a distance between the first light transmissive board and the second light transmissive board is less than half of a distance between the light board and the liquid crystal panel.

In some embodiments, the sidewall includes a dust-proof tape.

According to another aspect of the present disclosure, a display device is provided, including the display module according to any embodiment of the aforementioned aspects.

In some embodiments, the display device further includes: a frame, covering at least a portion of the display module, and made of a thermally conductive material, in which at least a portion of the first ventilation duct and the second ventilation duct extends closely to the frame.

Based on the embodiments described below, these and other aspects of the present disclosure will be clear and will be elucidated with reference to the embodiments described below.

### BRIEF DESCRIPTION OF DRAWINGS

In the following description of exemplary embodiments in conjunction with the accompanying drawings, more details, features and advantages of the present disclosure will be disclosed. In the accompanying drawings:

FIG. 1 illustrates a schematic diagram of a display module in related arts;

FIG. 2 illustrates a schematic diagram depicting the heat dissipation path of an example display module in related arts;

FIG. 3A illustrates a schematic diagram of a single-layer one-dimensional heat conduction model;

FIG. 3B illustrates a schematic diagram of a multi-layer one-dimensional heat conduction model;

FIG. 4 exemplarily illustrates a schematic diagram of a display module according to some embodiments of the present disclosure;

FIG. 5 exemplarily illustrates another schematic diagram of a display module according to some embodiments of the present disclosure;

FIG. 6 illustrates a schematic diagram depicting the heat dissipation path of a display module according to some embodiments of the present disclosure;

FIG. 7 exemplarily illustrates a schematic diagram of an air cavity member according to some embodiments of the present disclosure;

FIG. 8 exemplarily illustrates the schematic assembly process of an air cavity member according to some embodiments of the present disclosure;

FIG. 9 exemplarily illustrates the schematic assembly process of a sealed cavity component according to some embodiments of the present disclosure;

FIG. 10 exemplarily illustrates another schematic assembly process of a sealed cavity component according to some embodiments of the present disclosure;

FIG. 11 exemplarily illustrates another schematic diagram of a display module according to some embodiments of the present disclosure;

FIG. 12 schematically illustrates an example circuit diagram of an air pump control circuit according to some embodiments of the present disclosure;

FIG. 13 exemplarily illustrates an exploded view of the structure of a display module according to some embodiments of the present disclosure;

FIG. 14 exemplarily illustrates a schematic diagram of a back board of a display module according to some embodiments of the present disclosure;

FIG. 15 exemplarily illustrates another schematic diagram of a back board of a display module according to some embodiments of the present disclosure;

FIG. 16 exemplarily illustrates another exploded view of the structure of a display module according to some embodiments of the present disclosure;

FIG. 17 exemplarily illustrates the schematic assembly process of a display device according to some embodiments of the present disclosure.

### DETAILED DESCRIPTION OF EMBODIMENTS

In the following, the technical solution in embodiments of the present disclosure will be described clearly and completely with the accompanying drawings. It should be understood that the described embodiments are only part of the embodiments of the present disclosure, not all of the embodiments. Based on the embodiments described in the present disclosure, all other embodiments obtained by those of ordinary skills in the art without creative work pertain to the protection scope of the disclosure. It will be understood by those skilled in the art that the embodiments described below are intended to explain the present disclosure and should not be regarded as limiting the present disclosure. Unless otherwise specified, if the specific technology or condition is not explicitly described in the following embodiments, those skilled in the art may understand them according to the technology or condition commonly used in the art or according to the product specification.

In the description of this specification, descriptions referring to the terms “one embodiment”, “another embodiment” and etc. mean that a specific feature, structure, material or characteristic described in connection with the embodiment is included in at least one embodiment of the present disclosure. In this specification, the schematic expressions of the above terms are not necessarily for the same embodiment or example. Moreover, the specific features, structures, materials or characteristics described may be combined in any one or more embodiments or examples in suitable manners. In addition, without contradiction, those skilled in the art may combine the different embodiments or examples described in the description or combine the features of different embodiments or examples. In addition, it should be noted that in the specification, the terms “first”, “second” and etc. are only used for descriptive purposes, and should not be understood as indicating or implying relative importance or implicitly indicating the number of indicated technical features.

Through research on related art, the applicant has found that for display devices such as liquid crystal screens, how to implement screen heat dissipation more effectively is still an urgent problem to be solved. For example, for outdoor liquid crystal screens (sometimes also known as “outdoor digital signage”), their working conditions are often harsh. According to experiments, at 3 pm in May, under direct sunlight, the temperature of a screen in the non-working state can reach around 63° C. For outdoor display scenes, such as bus stop signs, supermarket entrances and etc., or semi-outdoor display scenes, such as display windows and etc., due to the influence of ambient light, such as daytime sunlight, a certain visual contrast ratio, i.e. Ambient Contrast Ratio (ACR), is usually required to ensure the display effect. Therefore, it is generally necessary to display at a high brightness, such as 3500 nits or higher. As mentioned above, under direct sunlight in summer, the temperature of a screen in the non-working state can reach over 60° C. Under such conditions, being turned on and working at a high brightness, the temperature of the screen may reach 80° C. or even higher. In such case, the temperature of the screen may already be very close to the clearing point of the liquid crystal, which may lead to uneven brightness, such as a Mura phenomenon, and at the same time, the white temperature shift may increase, such as shifting upwards by more than 3000 K. The color temperature shift may be solved through color temperature compensation. However, the power of the device may increase by more than 15% if adopting the color temperature compensation while ensuring the same brightness, which will further exacerbate the heat accumulation inside the device. In addition to the impact on display performance, long-term high temperature may also have adverse effects on the performance degradation of structures such as film materials, thereby reducing the service life of the device.

Furthermore, the applicant has found that in the related art, in order to ensure the heat dissipation effect of the display device in the above scenes, the liquid crystal display module being used generally adopts a direct type for light mixing. In addition, the aluminum based back board, point to point silicone, fin-type aluminum back board, air cooling and other approaches may be used to improve the heat dissipation effect. However, these heat dissipation approaches are designed to reduce the temperature on the back board side, which can lower the temperature of components such as the power board, SOC (System on Chip) board, T-CON (Time Controller) board, LED driver board and etc., allowing these components to operate within a controllable quality range and increasing their lifespans. However, these beat dissipation approaches cannot effectively reduce the temperature on the liquid crystal panel side. This is because, although there's a little part of the heat flux generated by the light board that can reach the liquid crystal panel through the light mixing distance (also referred to as optical distance, OD) since the thermal conductivity of air is much lower than that of the thermal conductive silicone and aluminum, due to the fact that the OD distance is generally not very large and the OD region is generally air tight for dust prevention and other factors, the heat in this area is difficult to dissipate and will continue to accumulate, causing the temperature in this area to continue to increase, which in turn leads to a continuing increase of the temperature of the liquid crystal panel until it approaches the temperature of the light board.

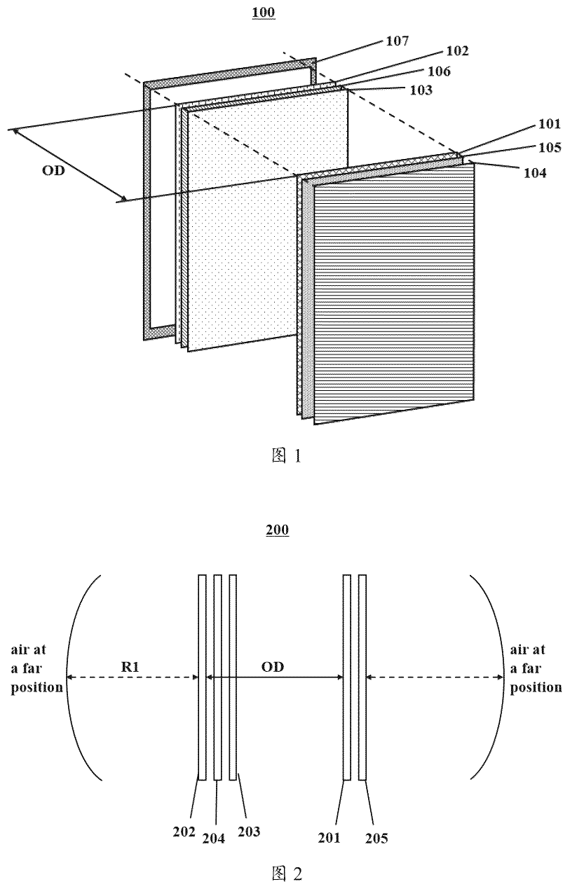

Exemplarily, FIG. 1 shows a schematic diagram of a display module 100 in the related art. As shown in FIG. 1, the display module may include a light board 101 and a liquid crystal panel (also referred to as an open cell, OC) 102, in which the light board 101 provides backlight, and the liquid crystal panel 102 can achieve a desired display effect under illumination of the backlight and driving of the related circuit. In addition, the display module 100 may also include one or more of a diffusion board 103 for making the backlight uniform, a back board 104, a reflective sheet 105 for reflecting the backlight, a color film 106 for filtering the backlight and a frame 107. Optionally, the display module 100 may also include other additional structures. As shown in FIG. 1, the backlight generated by the light board 101 may reach the OC 102 through the diffusion board 103 and the color film 106. The distance between the OC 102 and the light board 101 may be referred to as the light mixing distance (also optical distance, OD).

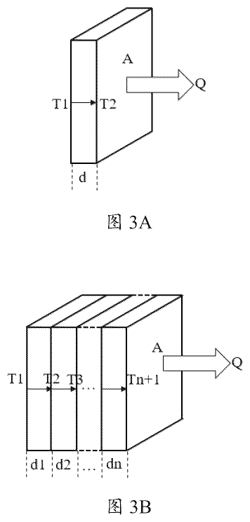

FIG. 2 illustrates a schematic diagram depicting the heat dissipation path of a display module such as that shown in FIG. 1. As shown in FIG. 2, on the one hand, the heat generated by the light board 201 is transferred to the back board 205, and transferred to the air through the back board 205 or the heat dissipation structure set on or near the back board 205. On the other hand, the heat generated is transferred to the OC 202 through the diffusion board 203, color film 204 or other structures in the OD region.

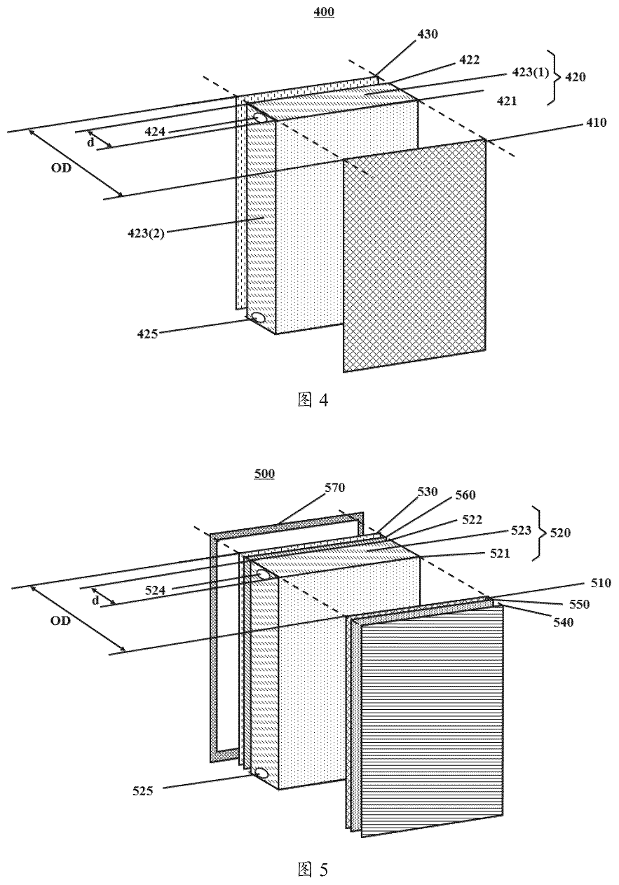

Due to the distance between OC 202 and light board 201 being much smaller than the length and width of OC 200, the heat conduction in the OD region can be approximately analyzed according to the one-dimensional heat conduction law, specifically according to the following equation (1):

$$d Q = λ \frac{\partial T}{\partial x} \cdot dSdf \qquad ( 1 )$$

in which dQ denotes the conducted heat, λ denotes the thermal conductivity, ∂T denotes the temperature difference, ∂x denotes the flow length, dS denotes the heat transfer area, and dt denotes the flow time. Furthermore, for one-dimensional thermal conduction of single-layer material, the model shown in FIG. 3A can be referred to. Specifically, in the case shown in FIG. 3A, in conjunction with equation (1), for one-dimensional heat conduction of single-layer material, the following equation holds;

$$Δ T = T 1 - T 2 = \frac{Q \cdot d}{λ \cdot A} \qquad ( 2 )$$

in which T1 and T2 denote the temperatures at the first and second surfaces respectively, ΔT denotes the temperature difference between the two surfaces, Q denotes the heat transferred from the first surface to the second surface, d denotes the distance between the two surfaces, λ denotes the thermal conductivity of the material between the two surfaces, and A denotes the area of each of the two surfaces. For one-dimensional heat conduction of multi-layer materials, the model shown in FIG. 3B can be referred to. Specifically, in the case shown in FIG. 3B, in conjunction with equation (2), for one-dimensional heat conduction of multi-layer materials, the following equation holds:

$${T}_{n + 1} - {T}_{1} = ( {T}_{n + 1} - {T}_{n} ) + ( {T}_{n} - {T}_{n - 1} ) + ⋯ + ( {T}_{2} - {T}_{1} ) = - Q {\sum }_{i = 1}^{n} \frac{{d}_{i}}{{λ}_{i} A} \qquad ( 3 )$$

in which T₁ to Tₙ₊₁ denote the temperatures at the n+1 surfaces respectively, Q denotes the heat transferred from the first surface to the (n+1)-th surface, dᵢ denotes the distance between corresponding adjacent surfaces, λᵢ denotes the thermal conductivity of the material between corresponding adjacent surfaces, and A denotes the area of each surface. By referring to relevant documents, it can be known that the thermal conductivity of air is 0.01, the thermal conductivity of glass is 0.5-1, the thermal conductivity of soft PVC, PC, PMMA or other material commonly used as the diffusion board material is 0.14-0.25, the thermal conductivity of aluminum, commonly used as a back board material, is 237, and the thermal conductivity of thermal conductive silicone is 0.8-3. Referring to

FIG. 2, the thermal conductivities of the materials through which heat flows on the left side of light board 201 are between 0.01 and 0.25, while the material through which heat flows on the right side is mainly aluminum back board 205 (thermal conductive silicone is generally very thin), which has a much higher thermal conductivity than the materials on the left side. Therefore, the proportion of heat transferred to OC 202 in the heat generated by light board 201 is not high. However, as mentioned above, due to the accumulation of heat in the OD region and RI being much higher than OD, the temperature of OC 202 will be close to the temperature of the light board.

Based on the above considerations, the present disclosure provides a display module and display device that can effectively reduce the temperature on the OC side, thereby helping to improve the display effect and extend the service life of the module and device.

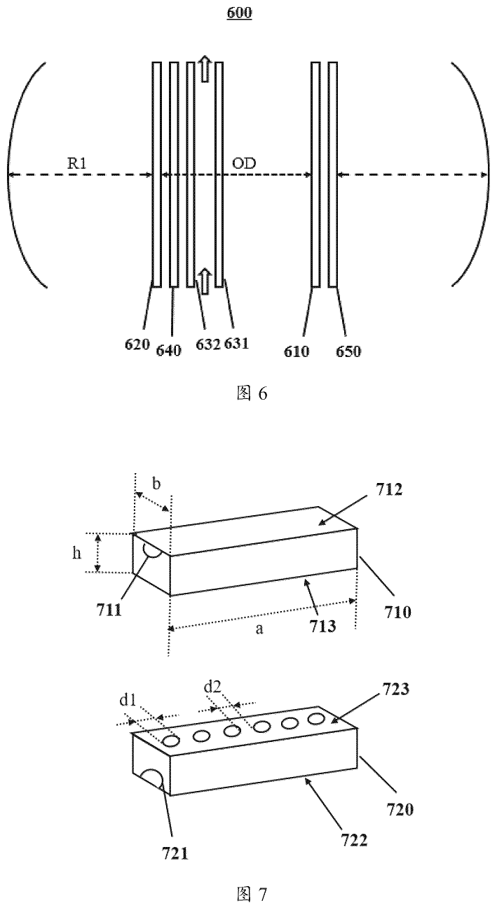

FIG. 4 exemplarily illustrates a schematic diagram of a display module 400 according to some embodiments of the present disclosure. As shown in FIG. 4, the display module 400 includes a light board 410, a sealed cavity component 420 and a liquid crystal panel (OC) 430. The light board 410 may be configured to emit light towards the side on which the sealed cavity 420 and the liquid crystal panel 430 are located. For example, the light board 410 may include a light source array, such as an LED array, for providing backlight. The sealed cavity component 420 includes a first light transmissive board 421 close to the light board 410, a second light transmissive board 422 away from the light board 410 and side walls 423(1) and 423(2) extending between the first light transmissive board 421 and the second light transmissive board 422. The first light transmissive board 421, the second light transmissive board 422 and the side wall 423 surround a cavity. The side wall 423 may have a first opening 424 and a second opening 425. The first opening 424 may be configured to output air from the cavity, and the second opening 425 may be configured to input air into the cavity. By the sealed cavity component 420, air flow in the cavity can be achieved through the first opening 424 and the second opening 425, thereby utilizing such air flow to dissipate heat in the OD region and reducing the temperature at OC 430.

The above display module 400 may be used in display devices with high brightness requirements as described above, e.g. in outdoor display scenes such as bus stop signs and supermarket entrances, or semi outdoor display scenes such as display windows. In such scenes, in general, the more concerned aspects are power consumption, image quality, temperature, etc., while the requirements for border width, overall weight, etc. are not strict. For the above display module 400, although the design of the sealed cavity component may increase the module weight, frame width, etc., this increase is not significant and is still within the acceptable range for outdoor or semi outdoor application scenes. Moreover, the heat dissipation effect brought by such design can significantly reduce the OC temperature, thereby improving the display effect, reducing power consumption, slowing down the decay rate of film materials and other structures, and enhancing the device's service life. Therefore, compared to the display modules in related art, the above display module 400 has a significant technological improvement effect. For example, with the above display module 400, it is possible to meet the high specification parameter requirements for outdoor high brightness LCD (Liquid Crystal Display), such as brightness of 3500 nits, operating temperature of −20° C. −60° C., and operating life of 5000 hours. However, it should be understood that although the display module proposed in the present disclosure is suitable for outdoor or semi outdoor high brightness display application scenes as described above, it can also be used for other indoor display application scenes and small display devices such as computer monitors and etc. The present disclosure does not impose any limitation on the specific application scope of the proposed solution.

In some embodiments, the first opening 424 and the second opening 425 may be arranged as shown in FIG. 4, that is, arranged on the lateral side wall of the sealed cavity component 420, in which the first opening 424 is arranged at the position near the top, and the second opening 425 is arranged at the position near the bottom. Here, the top and the bottom respectively refer to the upward part and the downward part of the display module 400 in its designed direction for use. For example, the display module 400 in FIG. 4 is drawn according to its designed direction for use, that is, 423(1) is the top side wall, the opposite side wall to 423(1) is the bottom side wall (not shown), and 423(2) and another side wall not shown are the lateral side walls. Due to the fact that hot air usually rises, the opening arrangement shown in FIG. 4 is beneficial for forming more sufficient air flow within the sealed cavity component 420 and achieving heat dissipation through such air flow. In addition, alternatively, the first and second openings may also be arranged differently from the arrangement shown in FIG. 4, for example, the two openings may be respectively set on different side walls, one or both of the two openings may be set on the top or bottom side wall, and so on.

In some embodiments, the first light transmissive board 421 and the second light transmissive board 422 may be made of the same or different light transmissive materials. For example, at least one of the first light transmissive board 421 and the second light transmissive board 422 may have a transmittance of 70% or more, 80% or more, or 90% or more. For example, at least one of them may be made of glass with high light transmittance. With the help of the glass with high light transmittance, the impact of the sealed cavity component on the light transmittance in the OD region can be reduced, which helps to reduce the increase in power consumption under the same display brightness and minimize the conversion of light loss into heat energy caused by low light transmittance, which may increase the heat dissipation burden. Further exemplarily, in some embodiments, the first light transmissive board 421 may be a high transmissive glass board, and the second light transmissive board 422 may be a diffusion board. In other words, compared to the display module in related art such as that shown in FIG. 1, the diffusion board may be replaced with a sealed cavity component with a sealed cavity, which includes a diffusion board and a high transmissive glass board (or other light transmissive boards) arranged opposite each other. Through such design, the production process of the sealed cavity component can be simplified, production costs can be reduced, and the impact of the sealed cavity component on the light transmittance in the OD region can be further reduced. At the same time, it can enhance the heat dissipation on the OC side without affecting the original OD length. Alternatively, in some embodiments, the first light transmissive board 421 and the second light transmissive board 422 may both be high transmissive glass boards. Alternatively, the first light transmissive board 421 may be a diffusion board, while the second light transmissive board 422 may be a high transmissive glass board, and so on.

Exemplarily, FIG. 5 illustrates a schematic diagram of a display module 500 according to some embodiments of the present disclosure. Similar to the display module 400 in FIG. 4, the display module 500 may include a light board 510, a sealed cavity component 520, and a liquid crystal panel 530. The sealed cavity component 520 may include a diffusion board 522 and a high transmissive glass board 521 arranged opposite each other, as well as a side wall 523 extending between the two boards. The side wall 523 may have a first opening 524 and a second opening 525. In addition, the display module 500 may optionally include other structures such as a back board 540, a reflective sheet 550, a color film 560, a frame 570 and etc.

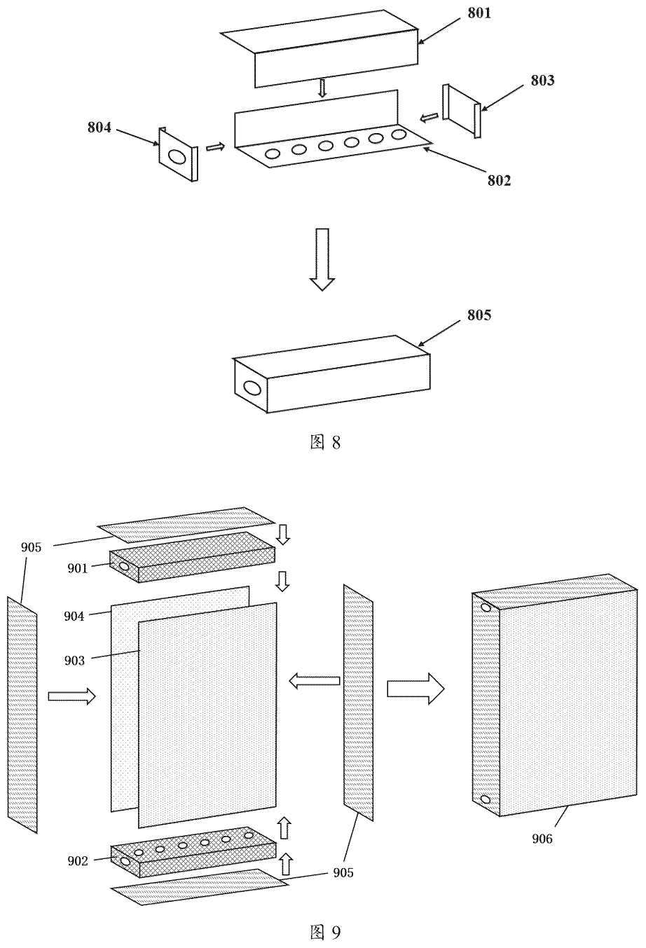

Schematically, FIG. 6 illustrates a diagram depicting the heat dissipation path of display module 400 or display module 500 according to some embodiments of the present disclosure. As shown in FIG. 6, a portion of the heat generated by the light board 610 may be transferred to the OC 620 through the OD region. In the process of heat being transferred to OC 620, the heat will pass through the first light transmissive board 631 and the second light transmissive board 632 of the sealed cavity component, in which the second light transmissive board 632 may be a diffusion board as mentioned above, and optionally also pass through the color film 640. In addition, another portion of the heat generated by the light board 610 may be transferred to the back board 650. As mentioned above, the sealed cavity component may have the first and second openings respectively configured to output air from and input air into the cavity, thereby enabling air flow between the first light transmissive board 631 and the second light transmissive board 632. This is equivalent to increasing the heat transfer area dS in equation (1) provided above, effectively reducing the temperature of OC 620, and optionally reducing the temperature of the color film 640, the second light transmissive board 632, etc. Specifically, given that the specific heat capacity C of air is approximately 1000 J/kg·° C., the amount of heat absorbed by the air as its temperature rises is:

$$Q = C \cdot M \cdot Δ T \qquad ( 4 )$$

in which C denotes the specific heat capacity of air, M denotes the mass of air, ΔT denotes the temperature rise of air circulation, and ΔT≈(Tₚₐₙₑₗ−T_{Ambient}), Tₚₐₙₑₗ denotes the OC temperature, T_{Ambient} denotes the ambient temperature. Hence, the heat carried away by the air per minute Q_{Dissipated} may be:

$${Q}_{Dissipated} = C \cdot M \cdot Δ T \cdot = C \cdot ρ \cdot V \cdot Δ T = C \cdot ρ \cdot {Q}_{Air} \cdot Δ T \qquad ( 5 )$$

in which Q_{Air} denotes the air flow rate per minute. By substituting the specific heat capacity of air C≈1000 J/kg·° C. and ρ=1.293 kg/m³ into equation (5) and assuming an air flow rate Q_{Air}=0.2 m³/minute, it can be concluded that the heat carried away by air circulation per minute is:

$${Q}_{Dissipated} = 1000 \times 1 \text{.293} \times 0.02 \times ( {T}_{Panel} - {T}_{Ambient} ) \qquad ( 6 )$$

According to the heat conduction equation (1) and substituting the thermal conductivity of air λ=0.015, the distance from the light board to the sealed cavity component (i.e. the light board to the first light transmissive board) ∂x=0.018 m, the cross-sectional area of the sealed cavity component (approximately the area of a 55 inch screen) S=1.2×0.68 m², and the time t=60 s (i.e. one minute), it can be concluded that the heat transferred from the light board to the sealed cavity component per minute is:

$${Q}_{Transferred} = - 0.015 \frac{( {T}_{Light board} - {T}_{Panel} )}{0.018} ( 1.2 \times 0.68 ) ) \qquad ( 7 )$$

When the temperatures of the OC and the second light transmissive board become stable, the heat transferred from the light board to the sealed cavity component should be equal to the heat carried away by the air circulation in the sealed cavity component. That is Q_{Dissipated}=Q_{Transferred}. Assuming the temperature of the light board T_{Light board}=70° C. and the ambient temperature T_{Ambient}=25° C., the OC temperature can be derived by equations (6) and (7) to be approximately Tₚₐₙₑₗ=31.132° C. According to actual measurement data, without setting a sealed cavity component, such as using the display module shown in FIG. 1, when the light board temperature is 70.81° C. and the ambient temperature is 24.6° C., the OC temperature is 53.2° C. Therefore, by comparison, when adopting the sealed cavity component provided in the present disclosure, theoretically, the OC temperature can be reduced by about 22° C.

Furthermore, the applicant also conducted a test by constructing test structures based on the display module provided in the present disclosure, such as the display module shown in FIG. 4 or FIG. 5. During the test, the temperature of the light board was 74.7° C., the ambient temperature was 24.3° C., and the measured OC temperature was 37.6° C. There is a certain difference between the test results and the theoretical results mentioned above, but it can still be seen that, compared to related art, the display module provided by the present disclosure can significantly reduce the OC temperature.

In some embodiments, the cavity thickness of the sealed cavity component may be less than half of the light mixing distance. That is, taking the display module 400 as an example, the distance between the first light transmissive board 421 and the second light transmissive board 422 (i.e., cavity thickness d) may be less than half of the distance between the light board 410 and the liquid crystal panel 430 (i.e., light mixing distance OD). Referring to equation (1) mentioned above, the difference between the light mixing distance OD and the cavity thickness d is approximately ∂x in the equation. With a fixed heat transfer area and a fixed thermal conductivity, the distance ∂x can determine the thermal resistance

$$R = \frac{\partial x}{λ \cdot dS}$$

for transferring heat from the light board to OC. Assuming all other conditions remain constant, the larger the thermal resistance R, the less heat is transferred from the light board to OC, and the smaller the thermal resistance R, the more heat is transferred from the light board to OC. In order to transfer more heat generated by the light board to the back board side, the aforementioned thermal resistance R should not be too small, so the thickness of the cavity should not be too large. For example, assuming the designed OD distance is 28 mm in total, the cavity thickness can be designed to be 10.5 mm, and the thermal resistance distance can be 17.5 mm. Setting the cavity thickness of the sealed cavity component to be less than half of the light mixing distance OD can maintain a high thermal resistance R while achieving the desired heat dissipation effect, resulting in less heat generated by the light board being transferred to the OC side. This helps to more effectively reduce the OC temperature.

In some embodiments, in the display module 400 shown in FIG. 4, the sealed cavity component 420 may include a first air cavity member and a second air cavity member. The first air cavity member may include a first extension portion extending along the upper side wall 423(1) of the sealed cavity component 420, which surrounds a first air cavity and has the first opening 424 at an end of the first extension portion. As mentioned above, the upper side wall is the upward side wall of the sealed cavity component in the designed direction for use of the display module. Similarly, the second cavity component may include a second extension portion extending along the lower side wall (not shown) of the sealed cavity component 420, which surrounds a second cavity and has the second opening 425 at an end of the second extension portion. The lower side wall is opposite to the upper side wall 423(1).

Exemplarily, FIG. 7 shows a schematic diagram of the first air cavity member 710 and the second air cavity member 720 according to some embodiments of the present disclosure. As shown in the figure, the first air cavity member 710 and the second air cavity member 720 may respectively include a first extension portion and a second extension portion with a rectangular cross-section. For example, the upper surface 712 of the first air cavity member 710 may extend along the upper side wall 423(1) of the sealed cavity component 420, such as being in close contact with or serving as the upper side wall 423(1). The lower surface 722 of the second air cavity 720 may extend along the lower side wall of the sealed cavity component 420, such as being in close contact with or serving as the lower side wall. In addition, in some embodiments, in order to facilitate processing and promote more sufficient air circulation to accelerate heat dissipation, as shown in FIG. 7, the first opening 711 may be arranged at a position near the upper surface 712 of the first air cavity member 710, and the second opening 721 may be arranged at a position near the lower surface 722 of the second air cavity member 720.

In some embodiments, the first extension portion of the first air cavity member 710 may have multiple third openings, which may be discretely arranged between the first air cavity and the cavity of the sealed cavity component, i.e., at the lower surface 713 in FIG. 7 (not shown). Similarly, the second extension portion of the second air cavity member 720 may have multiple fourth openings, which may be discretely arranged between the second air cavity and the cavity of the sealed cavity component, i.e., at the upper surface 723 in FIG. 7. By discretely arranging multiple third openings and multiple fourth openings, it helps to achieve a more uniform cooling effect.

To further ensure uniform heat dissipation, for example, the aforementioned discrete arrangement may be a uniform discrete arrangement, that is, the distance between each pair of adjacent openings may be kept consistent. Further exemplarily, the opening diameter d1 of each third or fourth opening may be 0.5-0.8 times the thickness of the cavity (i.e., the distance between the first light transmissive board and the second light transmissive board), and the opening spacing d2 between adjacent third/fourth openings may be, for example, 3-15 times the opening diameter.

For example, if the opening diameter of the third/fourth opening is 5 mm, then the opening spacing may be 50 mm, etc. Optionally, multiple third openings or multiple fourth openings may be arranged in one or two lines. For example, due to the small distance between the first light transmissive board and the second light transmissive board, they may be arranged in a single line and may be centrally arranged between the first light transmissive board and the second light transmissive board. Optionally, for ease of processing, the arrangement of multiple third openings and multiple fourth openings may be kept consistent. However, according to actual application requirements, the arrangement of the multiple third openings and the multiple fourth openings may also be different. Although the fourth openings are shown as circular in FIG. 7, according to actual application requirements, the third and fourth openings may be circular or in other shapes such as square, oval, etc. The present disclosure does not impose limitations on this.

The dimensions of the first air cavity member 710 and the second air cavity member 720 may be selected according to specific application requirements. For example, as shown in FIG. 7, the length a of the first air cavity member 710 may be consistent with the length of the upper edges of the first and second light transmissive boards, such as the length of the upper edges of the first and second light transmissive boards 421 and 422 in the display module 400. The width b may be consistent with the distance between the first light transmissive board and the second light transmissive board, that is, consistent with the thickness of the sealed cavity component. The height h may be selected based on one or several factors such as the size of the display area of the display module, the desired frame size, the parameters of the ventilation duct and air pump as used, and etc. For example, the height h may be selected as 1% to 3% of the diagonal length of the display area. For example, for a 55-inch display module, the height h may be selected as a value of 12 mm, 13 mm, and etc. Optionally, for ease of processing, the first air cavity member 710 and the second air cavity member 720 may have identical dimensions. Alternatively, depending on specific application requirements, they may also be designed to have different dimensions.

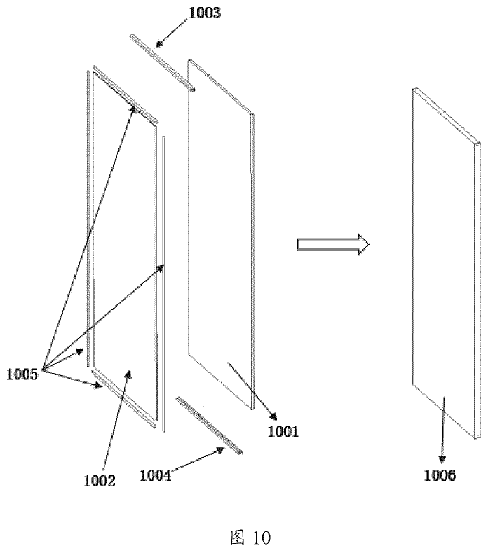

Schematically, FIG. 8 illustrates an example assembly process of the first and second air cavity members according to some embodiments of the present disclosure. As shown in FIG. 8, the surfaces 801, 802 and end faces 803, 804 of the extension portion of the first or second air cavity member may be obtained by extrusion molding. For example, the materials of the surfaces 801, 802 and end faces 803, 804 of the extension portion of the first or second air cavity member may be selected according to application requirements, such as glass, plastic, etc. Due to the fact that, in some embodiments, the first and second air cavity members may be arranged in non-display areas, such as being obscured by frames, the first and second air cavity members may also be made of non light transmissive materials. Multiple third or fourth openings may be obtained by discretely punching holes at the surface 802, and the first or second opening at the end face 804 may also be obtained by punching holes. The surfaces 801 and 802, as well as the end faces 803 and 804, may be assembled together by adhesive or other means to obtain the first or second air cavity member 805. Furthermore, the obtained first or second air cavity member 805 may be assembled with other structures to obtain the aforementioned sealed cavity component, which will be described in detail below.

To improve the dust prevention effect, in some embodiments, the side wall of the sealed cavity component may include a dust-proof tape. For LCD modules, the accumulation of dust in the OD region may affect brightness, reduce color temperature, and may cause Mura phenomenon. Therefore, to ensure the display effect without significantly increasing production costs, dust prevention may be achieved by using a dust-proof tape on the side wall of the sealed cavity component. For example, at least a portion of the surface of the side wall of the sealed cavity component may be provided with a dust-proof tape. For example, the dust-proof tape may be adhered to at least a portion of the surface of the structure surrounding the cavity of the sealed cavity component, or, to simplify the structure and facilitate assembly, the dust-proof tape may directly serve as at least a portion of the structure surrounding the cavity of the sealed cavity component.

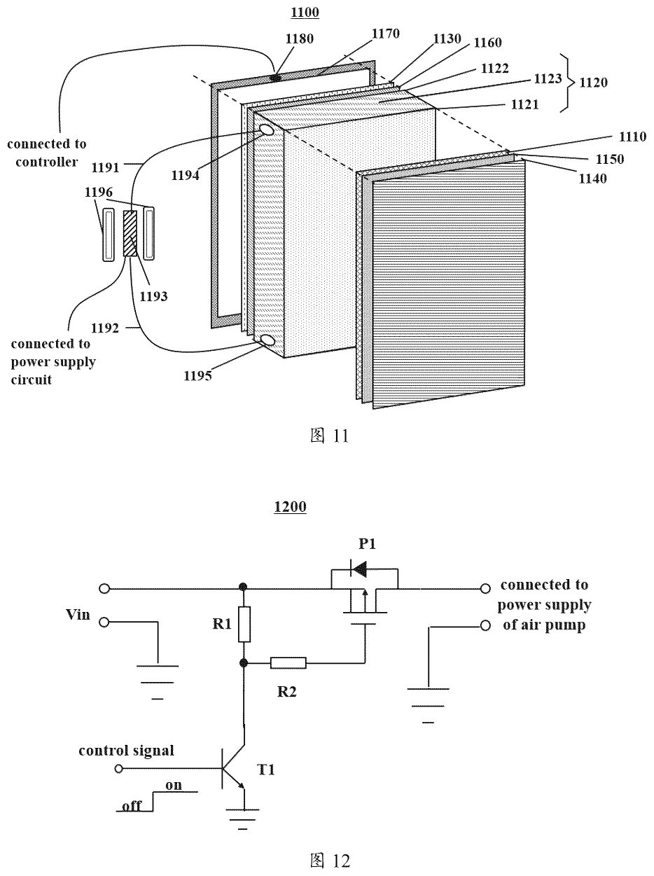

Exemplarily, FIG. 9 illustrates the schematic assembly process of a sealed cavity component according to some embodiments of the present disclosure. As shown in FIG. 9, the first air cavity member 901 and the second air cavity member 902 may be sandwiched between the first light transmissive board 903 and the second light transmissive board 904, the upper surface of the first air cavity member 901 may be flush with the upper edges of the first light transmissive board 903 and the second light transmissive board 904, and the lower surface of the second air cavity member 902 may be flush with the lower edges of the first light transmissive board 903 and the second light transmissive board 904. Dust-proof tape 905 may be applied to the four sides of the structure composed of the first air cavity member 901, the second air cavity member 902, the first light transmissive board 903 and the second light transmissive board 904. The applied dust-proof tape 905 plays a role for fixing on the one hand and plays a role for sealing against dust on the other hand. Through the above process, the assembly of the sealed cavity component 906 can be conveniently completed, and it can be ensured that the assembled sealed cavity component 906 has the desired dust-proof effect. In addition, alternatively, side boards may be installed between the first light transmissive board 903 and the second light transmissive board 904 in areas not covered by the air cavity members 901 or 902, i.e., on the left and right sides in the figure, and the dust-proof tape may be applied on top of the side boards afterwards. And, alternatively, the first air cavity member 901, the second air cavity member 902, and the optional side boards may be additionally fixed together with the first light transmissive board 903 and the second light transmissive board 904 through other means, such as adhesive bonding, etc. In addition, alternatively, the first and second air cavity members 901 and 902 may only be partially sandwiched between the first and second light transmissive boards 903 and 904, or in contact with the upper and lower edges of the first and second light transmissive boards 903 and 904 without being sandwiched between them. Optionally, the contact area between the first and second air cavity members 901 and 902 and the first and second light transmissive boards 903 and 904 may be fixed by adhesive, dust-proof tape, or other means.

Further exemplarily, as shown in the three-dimensional assembly diagram in FIG. 10, a diffusion board used in the display module in related art may be used as the second light transmissive board 1002, and a high transmissive glass board may be used as the first light transmissive board 1001. According to the method described in reference to FIG. 9, the first light transmissive board 1001 and the second light transmissive board 1002 are arranged opposite each other, and the first air cavity member 1003 and the second air cavity member 1004 are respectively assembled to the upper and lower edge positions between the first light transmissive board 1001 and the second light transmissive board 1002. Then, the dust-proof tape 1005 is applied to the periphery of the assembled first light transmissive board 1001 and the second light transmissive board 1002, as well as the first air cavity member 1003 and the second air cavity member 1004, to fix these components, obtaining the assembled sealed cavity component 1006. As shown in FIG. 10, the upper dust-proof tape 1005 may be adhered to the upper surface of the first air cavity member 1003 and the upper edges of the first and second light transmissive boards 1001 and 1002. The lower dust-proof tape 1005 may be adhered to the lower surface of the second air cavity member 1004 and the lower edges of the first and second light transmissive boards 1001 and 1002. The left dust-proof tape 1005 may be adhered to the left edges of the first and second light transmissive boards 1001 and 1002, as well as the left end faces of the first and second air cavity members 1003 and 1004. The right dust-proof tape 1005 may be adhered to the right edges of the first and second light transmissive boards 1001 and 1002, as well as the right end faces of the first and second air cavity members 1003 and 1004. The obtained sealed cavity component 1006 may be used to replace the diffusion board originally used in the display module. In this way, the sealed cavity component can be assembled at a lower cost, and better heat dissipation can be achieved without affecting the existing light mixing distance or increasing the thickness of the module.

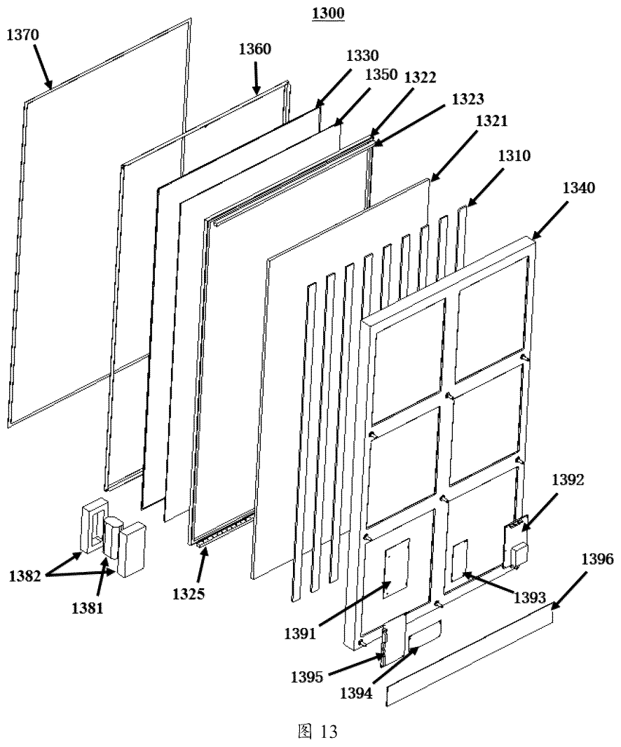

In some embodiments, the sealed cavity component of the display module may achieve air circulation and heat dissipation inside the cavity through the air pump and ventilation ducts that are connected to the first and second openings. Exemplarily, FIG. 11 illustrates a schematic diagram of a display module 1100 according to some embodiments of the present disclosure. As shown in FIG. 11, in addition to the light board 1110, sealed cavity component 1120, liquid crystal panel 1130, back board 1140, reflective sheet 1150, color film 1160, and frame 1170 mentioned in the previous embodiments, the display module 1100 may also include a first ventilation duct 1191, a second ventilation duct 1192, and an air pump 1193. The first port of the first ventilation duct 1191 may be connected to the first opening on the side wall 1123 of the sealed cavity component 1120, and the first port of the second ventilation duct 1192 may be connected to the second opening on the side wall 1123 of the sealed cavity component 1120. The air pump 1193 may be connected to the second port of the first ventilation duct 1191 and the second port of the second ventilation duct 1192, and may be configured to drive air to flow in the first ventilation duct 1191, the second ventilation duct 1192, and the cavity of the sealed cavity component 1120 surrounded by the first light transmissive board 1121, the second light transmissive board 1122 and the side wall 1123. The air pump 1193 may be connected to a power supply circuit and receive power from the power supply circuit. By using the air pump and ventilation ducts, it is easy to achieve air flow inside the sealed cavity, and the flow rate can be adjusted according to application requirements.

In the above embodiments, the sizes of the first and second openings may be determined based on the sizes of the air pump and ventilation ducts used. For example, if a VFY90S air pump is used, which suction/exhaust nozzle has an inner diameter of 3.2 mm and an outer diameter of 6.2 mm, and the matching silicone ventilation duct is with an inner diameter of 4 mm and an outer diameter of 8 mm, then the diameter of the first and second openings may be 8 mm. Optionally, the shape of the first opening 711 and the second opening 721 may be consistent with the cross-sectional shape of the ventilation ducts used, or slightly different from it, which difference can be compensated for by sealing rings or other structures. For example, according to specific application requirements, the first opening 711 and the second opening 721 may be circular, semi-circular, or in other shapes like square and etc.

In some embodiments, to further enhance the sealing and dust-proof effects, the display module 1100 may further include a first sealing ring 1194 and a second sealing ring 1195. The first sealing ring 1194 may be configured to seal the first opening between the first port of the first ventilation duct 1191 and the first opening, and the second sealing ring 1195 may be configured to seal the second opening between the first port of the second ventilation duct 1192 and the second opening. For example, the first sealing ring 1194 may be fitted around the first port of the first ventilation duct 1191 and inserted into the first opening together with the first port, and the second sealing ring 1195 may be similarly disposed.

In some embodiments, in order to reduce noise during the operation of the air pump, the display module 1100 may further include a shock-absorbing pad 1196, which may cover at least a portion of the surface of the air pump 1193. The shock-absorbing pad 1196 may include materials with shock-absorbing effect, such as sponge or the like. Optionally, the shock-absorbing pad 1196 may completely wrap around the air pump 1193, i.e. covering all surfaces of the air pump 1193 except for the air nozzle, to achieve the best shock absorption effect.

Optionally, in embodiments where the display module does not include components such as a first ventilation duct, a second ventilation duct, an electrical air pump, etc., the user of the display module may be allowed to configure the ventilation ducts, electrical air pumps, etc. themselves, or other matching devices that drive air to flow may also be used.

In some embodiments, in order to avoid the continuous operation of the air pump, which not only increases power consumption but also reduces the service life of the air pump, a temperature sensor may be arranged to collect the temperature on the OC side, and the switch of the air pump may be controlled based on the collected temperature. For example, as shown in FIG. 11, the display module 1100 may also include a temperature sensor 1180, which may be installed on the first side of the light board 1110, i.e., its light-emitting side. The temperature sensor 1180 may sense the temperature at its installation position and transmit the sensed temperature signal to the connected controller, such as an SOC board, through a signal line. The controller may be configured to generate a control signal based on the temperature sensed by the temperature sensor, which may be used to control the air pump 1193 to be turned on or turned off. Optionally, the temperature sensor 1180 may be a TMP117 sensor with I2C communication, or any other suitable sensor may be selected according to specific requirements. By controlling the on-and-off of the air pump by the temperature sensor and controller, the service life of the air pump can be extended while the heat dissipation requirements are well met.

Further exemplarily, the above controller may control the on-and-off of the air pump 1193 based on the relationship between the sensed temperature and the temperature threshold, so as to control the temperature of the first side of the light board 1110 at or near the temperature threshold. To avoid frequent switching of the air pump 1193, optionally, the controller may be further configured to generate, in response to the sensed temperature being greater than a first threshold, a first control signal for controlling the air pump 1193 to be turned on, and generate, in response to the sensed temperature being lower than a second threshold, a second control signal for controlling the air pump 1193 to be turned off, in which the second threshold is lower than the first threshold. Thus, the temperature on the first side of the light board 1110 can be controlled between the first threshold and the second threshold. By setting the first and second thresholds reasonably, it is possible to avoid frequent or prolonged operation of the air pump while ensuring the heat dissipation effect. Optionally, the first control signal may be a high-level signal, and the second control signal may be a low-level signal, or the first control signal may be a preset signal, the second control signal may be a stop of the preset signal, and so on.

Due to heat goes up, in general, the temperature at the top of the screen is the highest. In order to quickly sense the temperature changes on the first side of the light board and achieve better temperature control effect, in some embodiments, as shown in FIG. 11, the temperature sensor 1180 may be arranged on the upper part of the liquid crystal panel 1130, for example, sandwiched between the upper part of the liquid crystal panel 1130 and the frame 1170. The upper part mentioned here may be understood as the upper portion of the liquid crystal panel in the designed direction for use of the display module, such as the direction as shown in FIG. 11.

For example, the air pump 1193 may be powered by the circuit 1200 shown in FIG. 12. As shown in FIG. 12, the pair of terminals on the right side of the circuit 1200 may be connected to the power supply of the air pump, the pair of terminals on the upper left side may be connected to the power terminals of the air pump and used to provide input voltage Vin to the air pump, and the terminal on the lower left side may be connected to a controller, such as an SOC board, to receive the control signal from the controller. Specifically, the controller may read the temperature data sensed by the temperature sensor 1180 and output the control signal according to the logic described in the previous embodiment. The control signal may be transmitted to the circuit 1200 to control the power supply of the air pump, thereby achieving the purpose of controlling the air pump to be turned on or turned off. For example, with the help of the circuit 1200, when the temperature sensed by the temperature sensor is higher than a first threshold, such as 40° C., the controller may output a high-level control signal, causing P1 to conduct, and then the air pump can receive power from the power source and start working. When the temperature sensed by the temperature sensor is below a second threshold, such as 35° C., the controller may output a low-level control signal, causing P1 to cut off, and then the air pump cannot receive power from the power source and stops working. Thus, the on-and-off of the air pump can be conveniently controlled based on temperature.

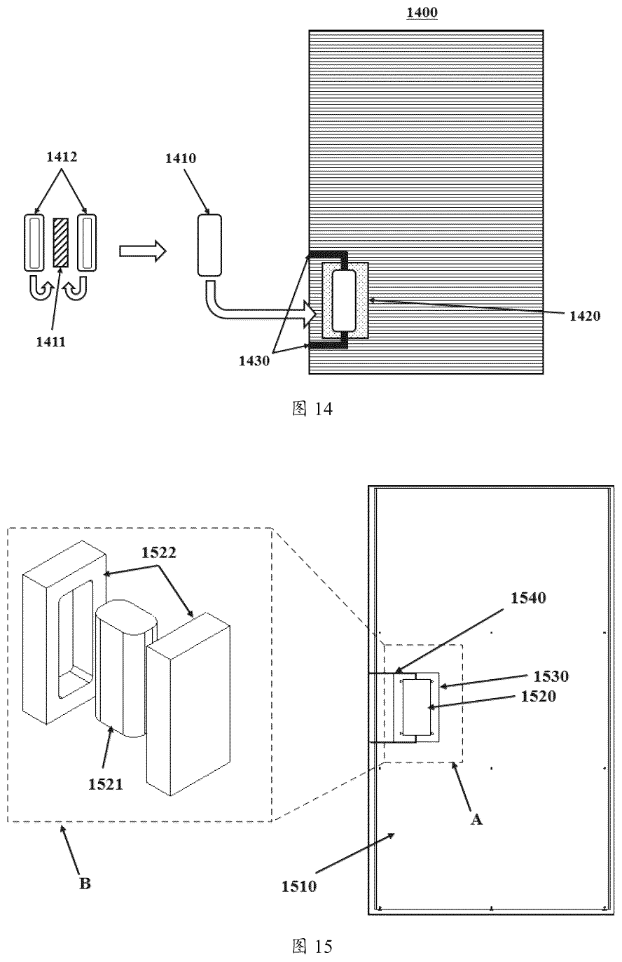

To illustrate the structure of the display module more intuitively, FIG. 13 exemplarily shows an exploded view of the structure of the display module 1300 according to some embodiments of the present disclosure. As shown in the figure, the display module 1300 may include multiple stacked structures. Specifically, the display module 1300 may include a light board 1310, a first light transmissive board 1321, a second light transmissive board 1322, and a liquid crystal panel 1330. The first light transmissive board 1321, the second light transmissive board 1322, the first air cavity member 1323, and the second air cavity member 1324 may be assembled into a sealed cavity component, and the assembly process may be similar to the process described with reference to FIG. 9 or FIG. 10. Optionally, the first light transmissive board 1321 may be a high light transmissive glass board, and the second light transmissive board 1322 may be a diffusion board. In addition, the display module 1300 may also include structures such as a back board 1340, a color film 1350, a front frame 1360, a cover glass 1370, etc., in which the back board 1340, the front frame 1360, etc. may play a role in supporting other structures, the cover glass 1370 may provide a smooth display surface for the module, and the color film 1350 may play a role of light filtering to optimize the display effect. Optionally, various circuit structures may be arranged on the back board 1340 of the display module 1300, on the side away from the light board 1310, such as converter 1391, power board 1392, computing board 1393, TCON board 1394, system board (such as SOC board) 1395, XPCB 1396, etc. In addition, optionally, as shown in FIG. 13, the surface of the air pump 1381 may be wrapped by the shock-absorbing pad 1382, and the air pump 1381 may be placed on the side wall of the sealed cavity component, i.e., the component composed of the first light transmissive board 1321, the second light transmissive board 1322, the first air cavity member 1323, the second air cavity member 1324, etc. in FIG. 13, or placed on the back board 1340, for example, located on the same side as the converter 1391. The air pump 1381 may be connected to the corresponding openings in the first and second air cavity members 1323 and 1324 through ventilation ducts (not shown) to drive the air flow in the cavity of the sealed cavity component. The specific connection way may be similar to that described with reference to FIG. 11.

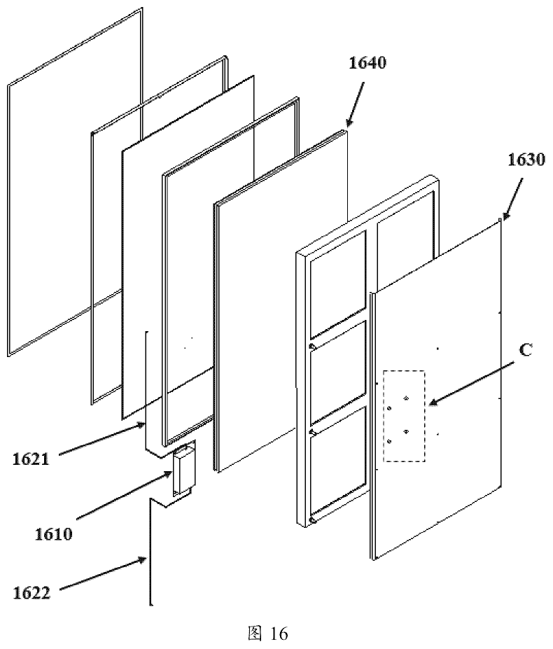

In some embodiments, in order to facilitate heat dissipation and save side space, the air pump may be arranged behind the back board, that is, on the side of the back board away from the light board. Optionally, the back board may be a board for arranging circuit boards such as the converter, the power board and etc., or another board different from the board, such as a packaging back board behind the board. Exemplarily, FIG. 14 illustrates a schematic diagram of a back board 1400 of a display module according to some embodiments of the present disclosure. As shown in FIG. 14, the periphery of the air pump 1411 may be covered with shock-absorbing pad 1412 to reduce working noise. The wrapped air pump component 1410 may be fixed to the back board 1400 of the display module on the side away from the light board through a bracket 1420. The bracket 1420 may be spaced by a certain distance from the back board 1400, such as 10 mm, for better heat dissipation. The air inlet and air outlet of the air pump 1411 may be connected to the ventilation ducts 1430, which includes the first and second ventilation ducts mentioned in the previous embodiments, and optionally, to enhance the dust prevention effect, the joint between the ventilation ducts 1430 and the air inlet and air outlet of the air pump 1411 should be locked and wrapped with a dust-proof tape.

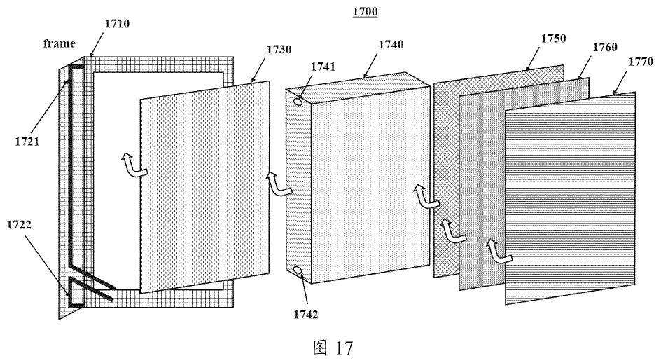

For a more intuitive display of the arrangement of the air pump behind the back board, please refer to FIGS. 15 and 16. As shown in box B in FIG. 15, the air pump 1521 may be completely wrapped by a shock-absorbing pad 1522 such as a shock-absorbing sponge, leaving only the air inlet and air outlet connected to the ventilation ducts 1540, to obtain the air pump assembly 1520 as shown in box A. The air pump assembly 1520 may be attached to the bracket 1530, for example, by adhesive bonding or other means. The bracket 1530 may be fixed to the rear side of the back board 1510, that is, the side away from the light board. Optionally, as shown in FIGS. 14 and 15, the air pump may be fixed to any appropriate position on the rear side of the back board, such as the lower or middle part of the rear side. As shown in FIG. 16, in order to arrange the air pump component 1610, which may be formed by wrapping the air pump with the shock-absorbing pad and optionally attached to a bracket, on the rear side of the back board 1630, such as the area indicated by box C, during assembly, the first ventilation duct 1621 and the second ventilation duct 1622 that are connected with the first and second openings of the sealed cavity component 1640 may be bent towards the side of the back board 1630 as shown in the figure and wound to the rear side of the back board 1630. Optionally, the ventilation duct may adopt a deformable semi-flexible duct to facilitate flexible placement of the air pump.

As mentioned above, the present disclosure also provides a display device, which may include the display module described in any of the previous embodiments. The display device may achieve better heat dissipation, especially better heat dissipation on the front side of the light board, such as at the OC, without significantly increasing production costs or affecting the size of the finished product. Therefore, the display device may have better display effect and longer service life.

In some embodiments, the display device may further include a frame that covers at least a portion of the display module and is made of a thermally conductive material, in which at least a portion of the first ventilation duct and the second ventilation duct in the display module extend closely to the frame. Here, extending closely to the frame can be understood as at least a portion of the first and second ventilation ducts being seamlessly attached to the frame or attached to the frame through materials such as thermal conductive adhesive. In this way, the overall frame of the display device can be used to dissipate heat from the air in the ventilation duct, so as to more efficiently reduce the screen temperature or maintain the screen temperature within a desired temperature range.

Exemplarily, FIG. 17 illustrates the schematic assembly process of a display device 1700 according to some embodiments of the present disclosure. As shown in the figure, the display device 1700 may have a frame 1710, which may be, for example, a metal frame. A portion of the ventilation ducts, including the first ventilation duct 1721 and the second ventilation duct 1722, may extend along the left or right side wall of the frame and may be closely attached to the side wall. The OC 1730, the sealed cavity component 1740, the light board 1750, the reflective sheet 1760, the back board 1770, and other structures may be sequentially assembled into the frame 1710. In addition, during the assembly process, the first port of the first ventilation duct 1721 and the first port of the second ventilation duct 1722 may be respectively connected to the first opening 1741 and the second opening 1742 of the sealed cavity component, and the second port of the first ventilation duct 1721 and the second port of the second ventilation duct 1722 may be connected to an air pump (not shown) fixed at the rear side or other positions of the back board 1770.

By studying the accompanying drawings, disclosed content and the attached claims, those skilled in the art may understand and implement variations of the disclosed embodiments when practicing the claimed subject matter. In the claims, the word “comprise” does not exclude other elements or steps, and “a” or “an” does not exclude multiple. The mere fact that certain measures are recorded in different dependent claims does not imply that the combination of these measures cannot be combined for benefit.

1. A display module comprising:
a light board, configured to emit light towards a first side;
a sealed cavity component, on the first side of the light board, comprising a first light transmissive board close to the light board, a second light transmissive board away from the light board and a side wall extending between the first light transmissive board and the second light transmissive board, wherein the first light transmissive board, the second light transmissive board and the side wall surround a cavity, and the side wall has a first opening configured to output air from the cavity and a second opening configured to input air into the cavity; and
a liquid crystal panel, on a side of the sealed cavity component away from the light board.

2. The display module according to claim 1, wherein the first light transmissive board is a high transmissive glass board, and the second light transmissive board is a diffusion board.

3. The display module according to claim 1, wherein the first light transmissive board and the second light transmissive board are both high transmissive glass boards.

4. The display module according to claim 1, wherein the sealed cavity component comprises:
a first air cavity member, comprising a first extension portion extending along an upper side wall of the sealed cavity component, the first extension portion surrounding a first air cavity, and an end of the first extension portion having the first opening, wherein the upper side wall is an upward side wall of the sealed cavity component in a designed direction for use of the display module; and
a second air cavity member, comprising a second extension portion extending along a lower side wall of the sealed cavity component, the second extension portion surrounding a second air cavity, and an end of the second extension portion having the second opening, wherein the lower side wall is a side wall opposite to the upper side wall.

5. The display module according to claim 4, wherein the first extension portion has multiple third openings discretely arranged between the first air cavity and the cavity, and
wherein the second extension portion has multiple fourth openings discretely arranged between the second air cavity and the cavity.

6. The display module according to claim 1, further comprising:
a first ventilation duct, a first port of the first ventilation duct being connected to the first opening;
a second ventilation duct, a first port of the second ventilation duct being connected to the second opening; and
an air pump, connected to a second port of the first ventilation duct and a second port of the second ventilation duct, and configured to drive air to flow in the first ventilation duct, the second ventilation duct and the cavity.

7. The display module according to claim 6, further comprising:
a first sealing ring, configured to seal the first opening between the first port of the first ventilation duct and the first opening; and
a second sealing ring, configured to seal the second opening between the first port of the second ventilation duct and the second opening.

8. The display module according to claim 6, further comprising:
a back board, located on a second side of the light board, the second side being an opposite side of the first side,
wherein the air pump is fixed on a side of the back board away from the light board.

9. The display module according to claim 6, further comprising:
a shock-absorbing pad, covering at least a portion of a surface of the air pump.

10. The display module according to claim 6, further comprising:
a temperature sensor, installed on the first side of the light board and configured to sense temperature at its installation position; and
a controller, configured to generate a control signal based on the temperature sensed by the temperature sensor, wherein the control signal is used to control the air pump to be turned on or off.

11. The display module according to claim 10, wherein the controller is further configured to:
generate, in response to the temperature being greater than a first threshold, a first control signal for controlling the air pump to be turned on; and
generate, in response to the temperature being lower than a second threshold, a second control signal for controlling the air pump to be turned off, wherein the second threshold is lower than the first threshold.

12. The display module according to claim 10, wherein the temperature sensor is arranged on an upper part of the liquid crystal panel, the upper part being an upper portion of the liquid crystal panel in a designed direction for use of the display module.

13. The display module according to claim 1, wherein a distance between the first light transmissive board and the second light transmissive board is less than half of a distance between the light board and the liquid crystal panel.

14. The display module according to claim 1, wherein the side wall comprises a dust-proof tape.

15. A display device comprising the display module according to claim 1.

16. The display device according to claim 15, further comprising:
a frame, covering at least a portion of the display module and made of a thermally conductive material:
a first ventilation duct. a first port of the first ventilation duct being connected to the first opening; and
a second ventilation duct, a first port of the second ventilation duct being connected to the second opening,
wherein at least a part of the first ventilation duct and the second ventilation duct extends closely to the frame.
